(19) United States
(12) Patent Application Publication
(10) Pub. No.: US 2004/0228954 A1
(43) Pub. Date: Nov. 18, 2004

(54) Flavored milk manufacturing processes and compositions

(76) Inventor: Susy Tejayadi, Evansville, IN (US)

Correspondence Address: Kenneth D. Goetz, Mead Johnson & Company, 2400 W. Lloyd Expressway (A21), Evansville, IN, 47721-0001, US

(21) Appl. No.: 10/437,317

(22) Filed: May 13, 2003

(51) Int. Cl. A23L 3/16

(52) U.S. Cl. 426/521

(57) ABSTRACT

Aseptic flavored milk compositions and processes for manufacturing aseptic flavored milk compositions that utilize temperatures of from about 35 to 65° F. (2 to 18° C.). The process uses a unique blend of a stabilizing agent, a thickening agent, and an additive in combination with typical flavoring agents and one or more other optional ingredients, such as sweeteners, vitamins, and minerals, to form a stable aseptic flavored milk composition, particularly chocolate milk, suitable for consumption as a food.

### BACKGROUND OF THE INVENTION

This invention relates generally to flavored milk manufacturing processes and compositions, and particularly to aseptic flavored milk manufacturing processes that utilize relatively low temperatures.

Prior art processes for manufacturing aseptic flavored milk compositions involve heating pasteurized milk or milk powders to temperatures of from about 120 to 170° F. (19 to 77° C.) and then adding other ingredients such as stabilizers, flavoring agents, coloring agents, salts, sugars, vitamins, and minerals while maintaining the mixture at the above temperature. After all the necessary ingredients have been added, the resulting composition is homogenized, sterilized, cooled, and aseptically packed. The problem with this process is that not all manufacturing facilities have the equipment needed to heat the milk and keep the mixture at the required temperature during the process. Also, the use of high temperatures is inherently more dangerous to manufacturing personnel than the use of lower temperatures. Similarly, the use of high temperatures increases the energy expended in the manufacturing process and therefore the cost associated with manufacturing the flavored milk compositions.

U.S. Pat. No. 4,910,035, issued to Ellis on Mar. 20, 1990 (Assigned to Consolidated Flavor Corporation (Bridgeton, Mo.)), entitled “Process and product for making flavored milk” discloses a process for making chocolate milk and other specialty dairy drinks including mixing substantially pure lambda carrageenan, cocoa and/or other flavorings with a portion of the milk such that the lambda carrageenan has a high concentration of up to 2000 ppm, pasteurizing this mix, storing the mix, and later combining the mix with pasteurized milk prior to packaging to dilute the lambda carrageenan to about 300 to 600 ppm in the final product. U.S. Pat. No. 4,851,243, issued to Andersen, et al. on Jul. 25, 1989 (Assigned to Borden, Inc. (Columbus, Ohio)), entitled “Calcium fortified aseptically packaged milk” discloses a process for producing shelf-stable aseptically packaged calcium-fortified milk products. The aseptically packaged fortified milk has acceptable flavor, viscosity, and mouth feel. The product has dairy-case stability and grocery-shelf stability for more than two weeks. The product is made by the addition of tri basic calcium phosphate, carrageenan, and guar gum to the fresh milk, effecting hydration of the gums and assuring uniform distribution of the added materials in the milk.

The prior art does not, however, disclose low temperature processes for manufacturing aseptic flavored milk compositions. There is, therefore, a need for processes for manufacturing aseptic flavored milk compositions at relatively low temperatures to provide aseptic flavored milk compositions for consumption as a food.

### BRIEF SUMMARY OF THE INVENTION

According to this invention, novel manufacturing processes for manufacturing aseptic flavored milk compositions are provided that utilize temperatures of from about 35 to about 65° F. (about 2 to about 18° C.). The process of the invention comprises (a) pasteurizing a milk composition; (b) adjusting the temperature of the pasteurized milk composition to from about 35 to about 65° F. (about 2 to about 18° C.); (c) adjusting the pH of the pasteurized milk composition to from about 6.5 to about 7.5, if required; (d) adding a colloidal microcrystalline cellulose stabilizing agent to the pasteurized milk composition, alone or in combination with other aseptic flavored milk composition ingredients, in amounts of from about 0.1 to about 3 wt. %; (e) adding a thickening agent selected from the group consisting of guar gum, locust bean gum, alginates, carrageenans, xanthan gum, and mixtures thereof to the resulting mixture, alone or in combination with other aseptic flavored milk composition ingredients, in amounts of from about 0.01 to about 0.5 wt. %; (f) adding an additive selected from the group consisting of sodium hexametaphosphate, sodium polyphosphates, sodium citrate, sodium tetra pyrophosphate, sodium EDTA, and calcium chloride to the resulting mixture, alone or in combination with other aseptic flavored milk composition ingredients, in amounts of from about 0.05 to about 0.4 wt. %; (g) adding flavoring agents and any additional ingredients to the resulting mixture, alone or in combination, to produce the desired flavored milk composition; (h) adjusting the pH of the flavored milk composition to about 6.5 to about 7.5, if required; (i) homogenizing the flavored milk composition; and (j) sterilizing the flavored milk composition.

The sterilized flavored milk composition can then be aseptically packaged.

### BRIEF DESCRIPTION OF THE DRAWINGS

Not Applicable.

### DETAILED DESCRIPTION OF THE INVENTION

The term “weight percentages” and the acronym “wt. %” as used herein refer to weight percentages based on the total weight of the aseptic flavored milk composition in its final form with all ingredients added.

In one aspect, the present invention provides a process for manufacturing aseptic flavored milk compositions that utilizes relatively low temperatures. The process for making the compositions utilizes temperatures of from about 35 to about 65° F. (about 2 to about 18° C.). These temperatures are significantly lower than the 120 to 170° F. (19 to 77° C.) temperatures utilized by typical processes. The use of the low processing temperatures is possible because of the discovery that stabilizing agents such as of colloidal microcrystalline cellulose, thickening agents such as carrageenan, and additives such as sodium hexametaphosphate can be combined in the manufacturing process in a unique way that produces a stable flavored milk composition.

According to the present invention, milk is first pasteurized, typically by heating to from about 180 to about 190° F. (about 82 to about 88° C.) for about 30 seconds, and then cooled to a temperature of from about 35 to about 65° F. (about 2 to about 18° C.), preferably from about 39 to about 46° F. (about 4 to about 8° C.). All other ingredients are added to the milk at this temperature. However, because many ingredients are not easily mixed at these temperatures, careful selection of ingredients and processing steps are essential in making a stable aseptic flavored milk composition. The milk could be used in the process without the initial pasteurization step. The process would be equivalent but pasteurization is preferred to avoid the possibility of bacterial growth or other similar contamination during the process.

The pH of the pasteurized milk composition is checked and, if required, adjusted to a relatively neutral pH, i.e., from about 6.5 to about 7.5, preferably about 7.0. The pH is adjusted as required using any acid or base compatible with the present compositions, preferably citric acid, potassium hydroxide, or sodium phosphate dibasic. Adjusting the pH prior to addition of other ingredients stabilizes the milk and prevents milk protein precipitation caused by the minerals in the composition.

The aseptic flavored milk composition manufactured according to the above process comprises from about 80 to about 95 wt. % milk, about 0.1 to about 12 wt. % flavoring agent, about 0.1 to about 3 wt. % stabilizing agent, about 0.01 to about 0.5 wt. % thickening agent; and about 0.05 to about 0.4 wt. % additive. Preferably the flavored milk composition further comprises from about 0.5 to about 6 wt. % of a sweetener such as sugar or sucrose, about 0.01 to about 0.2 wt. % of one or more coloring agents, about 0.01 to about 1 wt. % of one or more vitamins, and about 0.01 to about 3 wt. % of one or more minerals.

A stabilizing agent is dispersed in the pasteurized milk composition in amounts of from about 0.1 to about 3 wt. % to form a stable three-dimensional matrix through hydrogen bond linkages. This creates a physical network that keeps the ingredients in suspension. The stabilizing agent can be added alone or in combination with one or more other ingredients used to make the aseptic flavored milk composition. In the preferred embodiment, the stabilizing agent is pre-blended with one or more other ingredients for ease of mixing and handling. Typically, the stabilizing agent is pre-blended with sucrose in amounts that facilitate mixing and handling depending upon the equipment available.

The stabilizing agent can be any agent that stabilizes the pasteurized milk composition. Preferably, the stabilizing agent is a colloidal microcrystalline cellulose. Colloidal microcrystalline cellulose is commercially available or can be produced by co-processing microcrystalline cellulose with a compound or mixture of compounds selected from the group consisting of sodium carboxymethyl cellulose, maltodextrin and xanthan gum, calcium alginate, sodium carboxymethyl cellulose and sodium stearoyl lactylate, and sodium stearoyl lactylate. The co-processing of microcrystalline cellulose with other compounds such as those described above to produce colloidal microcrystalline cellulose is well known in the art. Most preferably, the stabilizing agent is colloidal microcrystalline cellulose containing about 81 to about 88% microcrystalline cellulose and about 12 to about 19% sodium carboxymethyl cellulose. The product is commercially available under the trademark AVICEL CL-611 from FMC Corporation.

A thickening agent is added to the resulting mixture in amounts of from about 0.01 to about 0.5 wt. %. The thickening agent interacts directly or indirectly with the milk proteins in the composition and form linkages through ionic interactions. The thickening agent can be added alone or in combination with one or more other ingredients used to make the aseptic flavored milk composition. In the preferred embodiment, the thickening agent is pre-blended with one or more other ingredients for ease of mixing and handling. Typically, the thickening agent is pre-blended with sucrose in amounts that facilitate mixing and handling depending upon the equipment available.

The thickening agent can be any agent that increases the viscosity of the composition. Polysaccharides that exhibit thickening properties in milk compositions, such as those of the present invention, are particularly useful. Ideally, the thickening agent is one that permits a relatively small amount of thickening agent to be used to greatly increase the viscosity. Preferably, the thickening agent is a polysaccharide selected from the group consisting of guar gum, locust bean gum, alginates, carrageenans, xanthan gum, and mixtures thereof. Most preferably, the thickening agent is lambda carrageenan.

An additive that prevents or lessens gelation by milk proteins is added to the resulting mixture in amounts of from about 0.05 to about 0.4 wt. %. The additive can be added alone or in combination with one or more other ingredients used to make the aseptic flavored milk composition. In the preferred embodiment, the additive is added along with one or more other ingredients. Typically, the additive is pre-blended with various combinations of sugar, salt, coloring agents, milk powder, vitamins, or minerals in amounts that facilitate mixing and handling depending upon the equipment available. Such additive can be a combination of two or more additives as appropriate to produce the desired composition.

The additive can be any compound that stabilizes the composition. Generally, the additive is a compound with calcium sequestering properties or a compound that forms direct linkages with milk proteins. Preferably, the additive is selected from the group consisting of sodium hexametaphosphate, sodium polyphosphates, sodium citrate, sodium tetra pyrophosphate, sodium EDTA, calcium chloride, and combinations thereof.

The aseptic flavored milk compositions of the present invention can be prepared in a variety of flavors. Preferably, the compositions are prepared by adding one or more flavoring agents to the compositions. Examples of suitable flavoring agents include chocolate, vanilla, honey, coffee, or mocha flavoring agents or strawberry, banana, pineapple, or orange fruit flavoring agents. The flavoring agent(s) can be added alone or in combination with one or more other ingredients used to make the composition. In one preferred embodiment, the flavoring agent is a chocolate flavoring agent, preferably in the form of cocoa syrup or powder. In another preferred embodiment, cocoa syrup and vanilla flavor are added to the composition by simply pouring the syrup and flavor into the composition in the desired amounts. In a more preferred embodiment, the aseptic flavored milk composition is chocolate milk, preferably containing supplemental vitamins and minerals. The aseptic flavored milk compositions are useful as nutritional flavored foods for consumers, especially children.

The one or more flavoring agents are added to the resulting mixture in amounts sufficient to impart the desired flavor to the aseptic flavored milk compositions of the present invention. The amounts of flavoring agent can vary greatly depending upon the flavoring agent used. Selection of the type and amount of flavoring agent is well within the skill of those of ordinary skill in the art. If required, such ordinary skilled artisan can easily determine the amounts needed to achieve the desired taste through routine experimentation. A typical chocolate milk made according to the present invention will contain from about 6 to about 12 wt. % cocoa syrup and about 0.05 to about 0.3 wt. % vanilla flavor.

The pH of the composition is checked and, if required, adjusted to a relatively neutral pH, i.e., from about 6.5 to about 7.5 preferably about 7.0. The pH is adjusted as required using any acid or base compatible with the present compositions, preferably citric acid, potassium hydroxide, or sodium phosphate dibasic. Adjusting the pH prior to homogenization stabilizes the milk and prevents milk protein precipitation caused by the minerals in the composition.

The resulting flavored milk composition is homogenized, sterilized, and cooled to produce an aseptic flavored milk composition suitable for consumption as a food by consumers. Homogenization and sterilization can be accomplished using standard equipment known to skilled artisans. The product can be packaged for distribution and sale as desired using standard equipment known to those of ordinary skill in the art.

Preferably, one or more other ingredients are added to the composition to make a more desirable aseptic flavored milk composition. Vitamins and minerals that have a health benefit to the consumer can be added to the composition. Sweeteners such as sugar or sucrose and corn syrup or lactose can be added to enhance the flavor. One or more coloring agents that impart a pleasant and enticing color to the composition can be added. Salt, flavors, spices, artificial sweeteners, preservatives, and similar agents may be added to the composition as needed to produce a desirable and stable composition. The ingredients are added before making any required final pH adjustment.

The present invention embodies processes wherein certain non-critical steps can be taken in various sequences. For example, the flavoring agent can be added before the additive and the order of addition of the coloring agents, sweeteners, salt, milk powder, and the like is not critical. It is critical that the stabilizing agent and the thickening agent be added to the pH adjusted composition before the additive, flavoring agent and other compounds are added to the composition, although the order of adding the stabilizing agent and thickening agent is not critical. Preferably, the stabilizing agent is added before the thickening agent. Although not bound by theory, it is believed that the unique, possibly synergistic, interactions of the inventive stabilizing agents, thickening agents, and additives make possible the manufacture of stable aseptic flavored milk compositions at the relatively low temperatures.

In all process operations or steps, the ingredients are thoroughly mixed to produce a composition to be used in the next step. The mixing should be complete and ensure a thorough dispersion of the ingredients in the mixture. The mixing speeds and mixing times for particular steps will depend on the equipment available and the ingredients used. Such parameters are readily known by those of ordinary skill in the art. When working with large batches, the stabilizing agent and thickening agent, either alone or in combination with other ingredients, are often mixed with relatively small amounts of the liquid milk to facilitate mixing and handling. The resulting mixture is added into the batch and mixed. This process may be repeated if necessary to facilitate the process or maximize the efficient use of available equipment.

In another aspect, the present invention provides an aseptic flavored milk composition comprising from about 80 to about 95 wt. % milk, from about 0.1 to about 12 wt. % flavoring agent, from about 0.1 to about 3 wt. % stabilizing agent, from about 0.01 to about 0.5 wt. % thickening agent, and from about 0.05 to about 0.4 wt. % additive. Preferably, the flavoring agent is selected from the group consisting of chocolate, vanilla, honey, coffee, or mocha flavoring agents or strawberry, banana, pineapple, or orange fruit flavoring agents; the stabilizing agent is colloidal microcrystalline cellulose; the thickening agent is selected from the group consisting of guar gum, locust bean gum, alginates, carrageenans, xanthan gum, and mixtures thereof; and the additive is selected from the group consisting of sodium hexametaphosphate, sodium polyphosphates, sodium citrate, sodium tetra pyrophosphate, sodium EDTA, and calcium chloride.

Preferably, the flavored milk composition further comprises from about 0.5 to about 6 wt. % of a sweetener such as sugar or sucrose, about 0.01 to about 0.2 wt. % of one or more coloring agents, about 0.01 to about 1 wt. % of one or more vitamins, and about 0.01 to about 3 wt. % of one or more minerals. A typical flavored chocolate milk composition is shown in Table 1.

TABLE 1

| | wt. % |
|---|---|
| Whole milk, liquid | 85 |
| Cocoa syrup | 9.7 |
| Colloidal microcrystalline | 0.22 |
| cellulose, spray dried | |
| Carrageenan | 0.020 |
| Sodium hexametaphosphate | 0.1 |
| Milk, powder | 1.9 |
| Sugar | 1.6 |
| Flavor | 0.094 |
| Salt | 0.037 |
| Vitamin premix | 0.033 |
| Mineral premix | 0.018 |
| Colors | 0.0025 |

The aseptic flavored milk compositions are useful because they provide a nutritional food for consumers.

The invention having been generally described, the following examples are given as particular embodiments of the invention and to demonstrate the practice and advantages thereof. It is understood that the examples are given by way of illustration and are not intended to limit the specification or the claims to follow in any manner.

### EXAMPLE 1

20062 pounds (2329 gallons) of liquid whole milk containing 11.5 wt. % Total Solids, 3.0 wt. % protein, and 2.9 wt. % fat was pasteurized by heating to 180 to 190° F. for 22 to 25 seconds. The temperature of the pasteurized milk was adjusted to about 39 to 43° F. and the pH adjusted to about 7.0. The pasteurized milk was transferred to a 6600 gallon mixing tank.

Approximately 530 pounds (59 gallons) of liquid from mixing tank was transferred to a high-speed mixer. 25.35 pounds of colloidal microcrystalline cellulose and 27.56 pounds of sugar that had been pre-blended were added to the high-speed mixer. The resulting mixture was stirred and recirculated for 5 to 6 minutes at 400 rpm. This mixture was transferred to the mixing tank and mixed for approximately 3 minutes. These steps were repeated.

Approximately 353 pounds (39.6 gallons) of liquid from mixing tank was transferred to the high-speed mixer. 2.31 pounds carrageenan and 22 pounds sugar that had been pre-blended was added to the high-speed mixer. The resulting mixture was stirred and recirculated for 5 to 6 minutes at 400 rpm. This mixture was transferred to the mixing tank and mixed for approximately 3 minutes. These steps were repeated.

23.15 pounds of sodium hexametaphosphate, 441 pounds of skim milk powder, 264.6 pounds of sugar, a pre-blended mix of 8.8 pounds of salt and 6.6 pounds of sugar, a pre-blended mix of 0.55 pounds color brown and 2.2 pounds of sugar, and pre-blended mix of 0.0337 pounds of color red and 2.2 pounds of sugar were added to the mixing tank via an induction funnel and mixed thoroughly for approximately 15 minutes.

2293 pounds of cocoa syrup was added to the mixing tank via a diaphragm pump and mixed thoroughly for approximately 15 minutes.

Approximately 471 pounds (52.8 gallons) of liquid was transferred to the high-speed mixer.

4.2 pounds of mineral premix was added to high-speed mixer and mixed thoroughly for 3 minutes at 200 rpm. The resulting mixture was transferred to the mixing tank.

Approximately 471 pounds (52.8 gallons) of liquid was transferred to the high-speed mixer.

7.7 pounds of vitamin premix and 0.13 pounds of vitamin E were added to the high-speed mixer and mixed for 3 minutes at 100 rpm. The resulting mixture was transferred to the mixing tank.

22 pounds of vanilla flavor was added to the mixing tank via an induction funnel and thoroughly mixed for 10 minutes.

Samples were taken and checked for pH, TS, protein, fat, and vitamin C. All were within acceptable ranges.

The resulting composition was mixed for 3 to 5 minutes, homogenized at 175 bar, sterilized at 284° F. for 5 seconds, aseptically homogenized at 40 bar, and cooled. The sterilized composition was then aseptically packaged.

Obviously many modifications and variations of the present invention are possible in light of the above teachings. It is therefore to be understood that within the scope of the appended claims the invention may be practiced otherwise than as specifically described.

1. A process for producing aseptic flavored milk compositions, comprising:
(a) pasteurizing a milk composition;
(b) adjusting the temperature of the pasteurized milk composition to from about 35 to about 65° F.;
(c) adjusting the pH of the pasteurized milk composition to from about 6.5 to about 7.5, if required;
(d) adding a colloidal microcrystalline cellulose stabilizing agent to the pasteurized milk composition, alone or in combination with other aseptic flavored milk composition ingredients, in amounts of from about 0.1 to about 3 wt. %;
(e) adding a thickening agent selected from the group consisting of guar gum, locust bean gum, alginates, carrageenans, and xanthan gum to the resulting mixture, alone or in combination with other aseptic flavored milk composition ingredients, in amounts of from about 0.01 to about 0.5 wt.
(f) adding an additive selected from the group consisting of sodium hexametaphosphate, sodium polyphosphates, sodium citrate, sodium tetra pyrophosphate, sodium EDTA, and calcium chloride to the resulting mixture, alone or in combination with other aseptic flavored milk composition ingredients, in amounts of from about 0.05 to about 0.4 wt.
(g) adding one or more flavoring agents to the resulting mixture, alone or in combination, to produce the desired flavored milk composition;
(h) adjusting the pH of the flavored milk composition to about 6.5 to about 7.5, if required;
(i) homogenizing the flavored milk composition; and
(j) sterilizing the flavored milk composition.

2. The process of claim 1 wherein the colloidal microcrystalline cellulose is microcrystalline cellulose co-processed with a compound or mixture of compounds selected from the group consisting of sodium carboxymethyl cellulose, maltodextrin and xanthan gum, calcium alginate, sodium carboxymethyl cellulose and sodium stearoyl lactylate, and sodium stearoyl lactylate.

3. The process of claim 2 wherein the colloidal microcrystalline cellulose is microcrystalline cellulose co-processed with sodium carboxymethyl cellulose.

4. The process of claim 1 wherein the thickening agent is carrageenan.

5. The process of claim 1 wherein the additive is of sodium hexametaphosphate.

6. The process of claim 1 wherein the flavoring agent is cocoa syrup and vanilla flavor.

7. The process of claim 3 wherein thickening agent is carrageenan, the additive is sodium hexametaphosphate, and the flavoring agent is cocoa syrup and vanilla.

8. The process of claim 7 wherein the stabilizing agent, the thickening agent, the additive, and the flavoring agent are pre-mixed with one or more other ingredients to facilitate easy mixing and handling.

9. The process of claim 8 wherein the other ingredient is sucrose.

10. The process of claim 1 further comprising adding one or more additional ingredients selected from the group consisting of vitamins, minerals, sweeteners, milk powder, and coloring agents before making the final pH adjustment, if required.

11. An aseptic flavored milk composition, comprising:
(a) from about 80 to about 95 wt. % milk;
(b) from about 0.1 to about 12 wt. % flavoring agent;
(c) from about 0.1 to about 3 wt. % of a colloidal microcrystalline cellulose stabilizing agent;
(d) from about 0.01 to about 0.5 wt. % thickening agent selected from the group consisting of guar gum, locust bean gum, alginates, carrageenans, xanthan gum, and mixtures thereof; and
(e) from about 0.05 to about 0.4 wt. % additive selected from the group consisting of sodium hexametaphosphate, sodium polyphosphates, sodium citrate, sodium tetra pyrophosphate, sodium EDTA, and calcium chloride.

12. The composition of claim 11 wherein the flavoring agent is selected from the group consisting of chocolate, vanilla, honey, coffee, and mocha flavoring agents and strawberry, banana, pineapple, and orange fruit flavoring agents.

13. The composition of claim 11 wherein the flavoring agent is cocoa syrup.

14. The composition of claim 11 further comprising from about 0.5 to about 6 wt. % of a sweetener.

15. The composition of claim 14 wherein the sweetener is sucrose.

16. The composition of claim 11 further comprising from about 0.01 to about 0.2 wt. % of one or more coloring agents.

17. The composition of claim 11 further comprising from about 0.01 to about 1 wt. % of one or more vitamins.

18. The composition of claim 11 further comprising from about 0.01 to about 3 wt. % of one or more minerals.

19. The composition of claim 11 wherein the colloidal microcrystalline cellulose is microcrystalline cellulose co-processed with a compound or mixture of compounds selected from the group consisting of sodium carboxymethyl cellulose, maltodextrin and xanthan gum, calcium alginate, sodium carboxymethyl cellulose and sodium stearoyl lactylate, and sodium stearoyl lactylate.

20. The composition of claim 19 wherein the colloidal microcrystalline cellulose is microcrystalline cellulose co-processed with sodium carboxymethyl cellulose.

21. An aseptic chocolate flavored milk composition, comprising:
(a) about 85 wt. % milk;
(b) about 10 wt. % cocoa syrup;
(c) about 0.25 wt. % colloidal microcrystalline cellulose;
(d) about 0.025 wt. % carrageenan; and
(e) about 0.1 wt. % sodium hexametaphosphate.

22. The composition of claim 21 further comprising about 2 wt. % sucrose.

23. The composition of claim 22 further comprising about 0.04 wt. % vitamins and about 0.02 wt. % minerals.

24. The composition of claim 21 wherein the colloidal microcrystalline cellulose is microcrystalline cellulose co-processed with a compound or mixture of compounds selected from the group consisting of sodium carboxymethyl cellulose, maltodextrin and xanthan gum, calcium alginate, sodium carboxymethyl cellulose and sodium stearoyl lactylate, and sodium stearoyl lactylate.

25. The composition of claim 24 wherein the colloidal microcrystalline cellulose is microcrystalline cellulose co-processed with sodium carboxymethyl cellulose.
